(19) United States
(12) Patent Application Publication
(10) Pub. No.: US 2012/0204549 A1
(43) Pub. Date: Aug. 16, 2012

(54) CONDITIONAL LOAD SENSE CONTROL

(76) Inventor: Wade L. Gehlhoff, Shakopee, MN (US)

(21) Appl. No.: 13/370,948

(22) Filed: Feb. 10, 2012

Related U.S. Application Data
(60) Provisional application No. 61/441,453, filed on Feb. 10, 2011.

(51) Int. Cl. F15B 13/00

(52) U.S. Cl. 60/327; 60/459

(57) ABSTRACT

A method of controlling a hydraulic circuit having a pump, a hydraulic actuator, and a control valve disposed between the pump and hydraulic actuator is disclosed. The method includes selectively placing the hydraulic circuit between a work mode and a work standby mode based upon the relationship between the hydraulic actuator hydraulic pressure and at least one maximum pressure limit value. The work mode includes moving the control valve to an open position such that the pump and hydraulic actuator are in fluid communication with each other and commanding the pump to generate an output pressure value that is greater than the measured hydraulic actuator hydraulic pressure. The work standby mode includes moving the control valve to a closed position such that the pump is isolated from the hydraulic actuator and commanding the pump to generate an output pressure value that is independent of the measured hydraulic actuator hydraulic pressure.

### RELATED APPLICATIONS

This application claims a right of priority to U.S. Provisional Patent Application Ser. No. 61/441,453, filed Feb. 10, 2011, the entirety of which is hereby incorporated by reference herein.

### BACKGROUND

Work machines, such as fork lifts, wheel loaders, track loaders, excavators, backhoes, bull dozers, and telehandlers are known. Work machines can be used to move material, such as pallets, dirt, and/or debris. The work machines typically include a work implement (e.g., a fork) connected to the work machine. The work implements attached to the work machines are typically powered by a hydraulic system. The hydraulic system can include a hydraulic pump that is powered by a prime mover, such as a diesel engine. It is common in such machines for the hydraulic pump to provide fluid power to a variety of valves within the hydraulic system. Improvements are desired. For example, the work implement, such as the forks on a fork lift, are typically raised and lowered by the operation of a lever which activates one or more hydraulic actuators via a control valve. In systems where multiple valves, or other fluid power consuming devices, are provided with pressurized fluid from the same pump, the pump must be operated at a pressure sufficient to satisfy the valve or component with the highest pressure demand. In some instances, the hydraulic actuator in a work circuit will be exposed to an external induced load that exceeds the capability of the pump to generate sufficient pressure to actually lift the load. This condition, in some applications, will cause the pump to operate at its maximum output value even though the valve associated with the hydraulic actuator will remain closed because an insufficient pressure condition will exist. Where this occurs, energy is unnecessarily consumed in generating a higher pressure than is needed at other valves that are using flow in the system. Improvements are desired.

### SUMMARY

A method of controlling a hydraulic circuit having a pump, a hydraulic actuator, and a control valve disposed between the pump and hydraulic actuator is disclosed. In one step of the method, an indication that a work operation is desired by a work lever in the hydraulic circuit is received. In one embodiment the work operation is a lifting operation and the work lever is a lifting lever. In another step of the method, the measured hydraulic actuator hydraulic pressure is also received. The method also includes the step of placing the hydraulic circuit in a work mode when the when the measured hydraulic actuator hydraulic pressure is below a first maximum pressure limit value. The work mode includes moving the control valve to an open position such that the pump and hydraulic actuator are in fluid communication with each other. The work mode also includes commanding the pump to generate an output pressure value that is greater than the measured hydraulic actuator hydraulic pressure when the measured hydraulic actuator hydraulic pressure is below the maximum pressure limit. The method further includes the step of placing the hydraulic circuit in a work standby mode when the measured hydraulic actuator hydraulic pressure is above a second maximum pressure limit value. The work standby mode includes moving the control valve to a closed position such that the pump is isolated from the hydraulic actuator and commanding the pump to generate an output pressure value that is independent of the measured hydraulic actuator hydraulic pressure.

A hydraulic system for use in a mobile vehicle is also disclosed. In one embodiment, the hydraulic system includes an electronic controller, at least one hydraulic actuator, a hydraulic pump in communication with the electronic controller, and a control valve in communication with the electronic controller. The control valve is disposed between the pump and the hydraulic actuator and being movable from a closed position to an open position in which the hydraulic actuator and hydraulic pump are placed in fluid communication with each other. Also included is a first pressure sensor in communication with the electronic controller, the first pressure sensor being for measuring a hydraulic pressure between the control valve and the hydraulic actuator. A second pressure sensor is also provided that is in communication with the electronic controller, the second pressure sensor being for measuring a hydraulic pressure between the pump and the control valve. In one embodiment, the electronic controller is configured to operate the system between the work mode and the work standby mode wherein the work mode being initiated when the hydraulic pressure at the first pressure sensor is below a first maximum pressure limit value and wherein the work standby mode being initiated when the hydraulic pressure at the hydraulic pressure at the first pressure sensor is above a second maximum pressure limit value. In one embodiment, the work mode includes the control valve being in the open position and the pump being set to generate an output pressure value that is greater than the measured hydraulic actuator hydraulic pressure. In one embodiment, the work standby mode includes the control valve being in a closed position and the pump being set to generate an output pressure value that is independent of the measured hydraulic actuator hydraulic pressure.

An electronic controller for use in a hydraulic circuit having a pump, a hydraulic actuator, and a control valve disposed between the pump and hydraulic actuator is also disclosed. The electronic controller comprises a non-transient storage medium, a processor, and a control algorithm stored on the non-transient storage medium and executable by the processor. In one embodiment, the control algorithm is configured to allow the electronic controller to operate the hydraulic circuit between the work mode and the work standby mode, as described above

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a schematic view of a work machine having features that are examples of aspects in accordance with the principles of the present disclosure.

FIG. 2 is a schematic view of a portion of a hydraulic circuit suitable for use in the work machine shown in FIG. 1.

FIG. 3 is a schematic of an electronic control system for the hydraulic circuit shown in FIG. 2.

FIG. 4 is a process flow chart showing a method of operation of the work circuit shown in FIG. 2.

FIG. 5 is a process flow chart showing a method of operation of the work circuit shown in FIG. 2.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### General Description

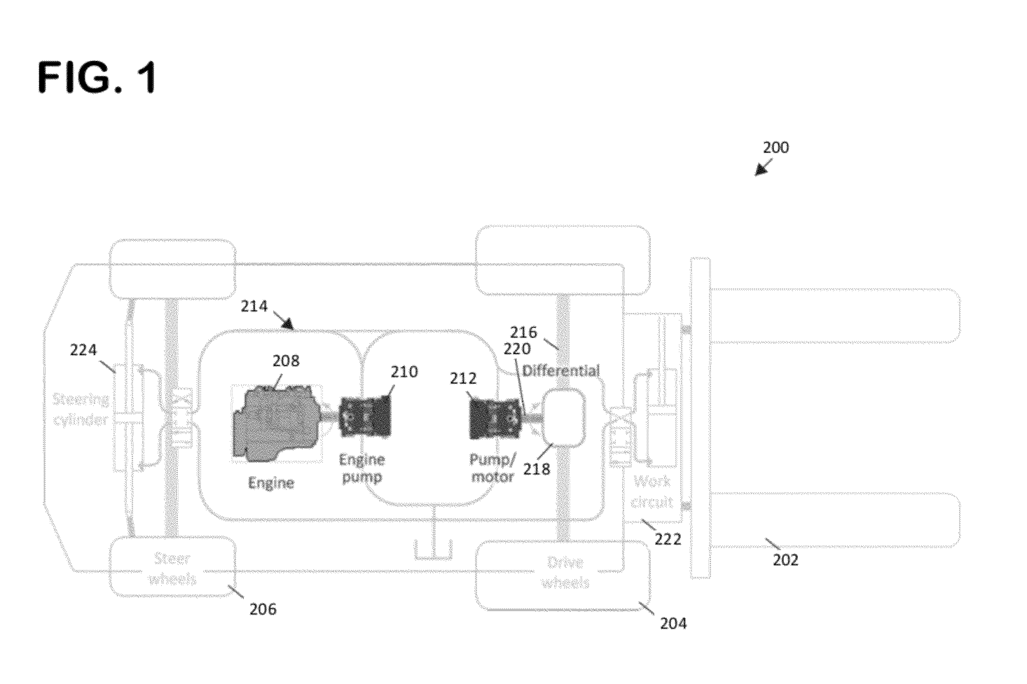

As depicted at FIG. 1, a work machine 200 is shown. Work machine 200 includes a work attachment 202 for performing a variety of work tasks. In one embodiment, work machine 200 is a fork lift truck and work attachment 202 comprises two forks. However, one skilled in the art will appreciate that work attachment may be any hydraulically powered work implement.

Work machine 200 is also shown as including at least one drive wheel 204 and at least one steer wheel 206. In certain embodiments, one or more drive wheels 204 may be combined with one or more steer wheels 206. The drive wheels are powered by an engine 208 in fluid communication with pumps 210 and 212. Pump 210 is mechanically coupled to the engine 208 while pump 212 is connected to the engine 208 via a hydraulic system 214. Pump 212 is also mechanically coupled to the drive wheel(s) 204 via axles 216, differential 218, and drive shaft 220.

A work circuit 222 and a steering circuit 224 are also in fluid communication with the hydraulic system 214. The work circuit 222 actuates the work attachment 22 such that the work tasks can be performed while the steering circuit 224 allows for the work machine 200 to be selectively steered in a desired direction.

### The Work Circuit

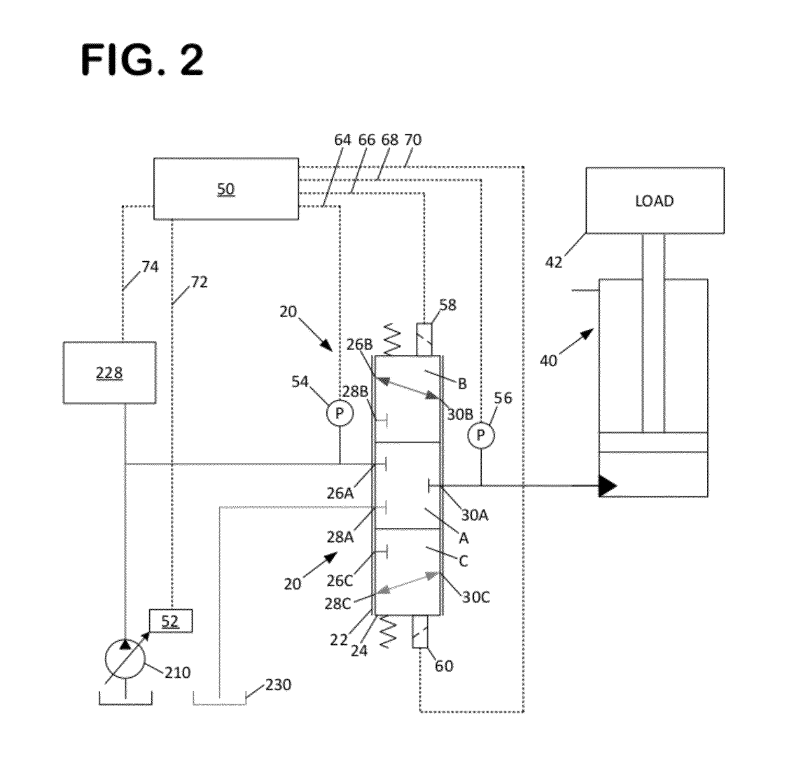

Referring to FIG. 2, examples of a work circuit 222 and other components of the hydraulic system are shown. Work circuit 222 is for activating the work attachment 202 of the work machine 200. Work circuit 222 includes a first valve assembly 20 for enabling a work function, such as an attachment lift function. Work circuit 222 may also include a plurality of additional valves and/or fluid power consuming components 228 for enabling other functions in the hydraulic system 214. In the particular embodiment shown, first valve assembly 20 is a proportional valve having a sleeve 22 within which a spool 24 is disposed.

The first valve assembly 20 is configured and arranged to selectively provide pressurized fluid from pump 210 to one or more hydraulic actuators 40 which can be mechanically coupled to the work attachment 202. By use of the term “hydraulic actuator” it is meant to include hydraulic cylinders (e.g. lift cylinders), hydraulic motors, and the like. In the exemplary embodiment shown in FIG. 2, the hydraulic actuator(s) 40 is a hydraulic lift cylinder. The operation of first valve assembly 20 causes the work attachment 202 to be selectively actuated in a work function. The actuation speed of the hydraulic actuator(s) 40 is a result of the flow through the first valve assembly 20. Flow through the first valve assembly 20 can be controlled by a pair of variable solenoid actuators 58, 60 acting on each end of the spool 24 of the valve 20. The variable solenoid actuators 58, 60 can be operated by the control system 50 via control lines 66, 70, respectively.

As shown, the first valve assembly 20 is a three-position, three-way valve in fluid communication with the pump 210, a tank reservoir 230, and the hydraulic actuator(s) 40. One skilled in the art will appreciate that two valves may be used instead of the single three-way valve 20. Alternatively, a single valve could be utilized that controls fluid into and out of the hydraulic actuator simultaneously, as shown generally at FIG. 1. In such an approach, one valve would be in fluid communication with the pump 210 and the hydraulic actuator(s) 40 while a second valve would be in fluid communication with the tank reservoir 230 and the hydraulic actuator(s) 40. In the embodiment shown, first valve assembly 20 is movable from a closed or neutral position A, to a work position B, and to a lowering position C.

In the closed position A, ports 26A, 28A, and 30A are closed such that the pump 210 and tank reservoir 230 are both isolated from the hydraulic actuator(s) 40. In this position the work attachment 202 is held in a static position and can be neither raised nor lowered.

In the work position B, the first valve assembly 20 is positioned such that ports 26B and 30B are placed in fluid communication with each other. This position allows for the pump 210 to be placed in fluid communication with the hydraulic actuator(s) 40. Where the pump pressure exceeds the pressure induced by a load 42, the hydraulic actuator(s) will cause the load 42 to be raised. In the work position, the tank reservoir 230 is blocked at port 28B.

In the lowering position C, the first valve assembly 20 is positioned such that ports 28C and 30C are placed in fluid communication with each other. This position allows for the tank reservoir 230 to be placed in fluid communication with the hydraulic actuator(s) 40. The lowering position C allows for fluid to drain from the hydraulic actuator(s) 40 to the tank reservoir 230, thereby allowing for the load 42 to be lowered.

The work circuit 222 is further shown as having a first pressure sensor 56 disposed between the hydraulic actuator(s) 40 and the first valve assembly 20. This sensor is placed in communication with the electronic controller 50 via control line 68. First pressure sensor 56 provides the controller 50 with an input for the pressure in the hydraulic hydraulic actuator(s) 40. When the first valve assembly 20 is in a closed position, first pressure sensor 56 provides an indication of the pressure induced on the system by load 42.

The work circuit 222 is further shown as having a second pressure sensor 54 disposed between the pump 210 and the first valve assembly 20. This sensor is placed in communication with the electronic controller 50 via control line 64. Second pressure sensor 54 provides the controller 50 with an input for the pressure generated by the pump 210. The pump output pressure can be controlled by a pump controller 52 in communication with electronic controller 50 via control lines 72.

In the embodiment shown, other control valves or pressure consuming devices 228 may or may not be part of the work circuit 222. These devices 228 can also be placed in communication with the electronic controller 50 via control line(s) 74.

### The Electronic Control System

The hydraulic system 214 operates in various modes depending on demands placed on the work machine 200 (e.g., by an operator). The electronic control system monitors and allows for the various modes to be initiated at appropriate times.

An electronic controller 50 monitors various sensors and operating parameters of the hydraulic system 214 to configure the hydraulic system 214 into the most appropriate mode. The modes include a work circuit work mode and a work circuit standby mode.

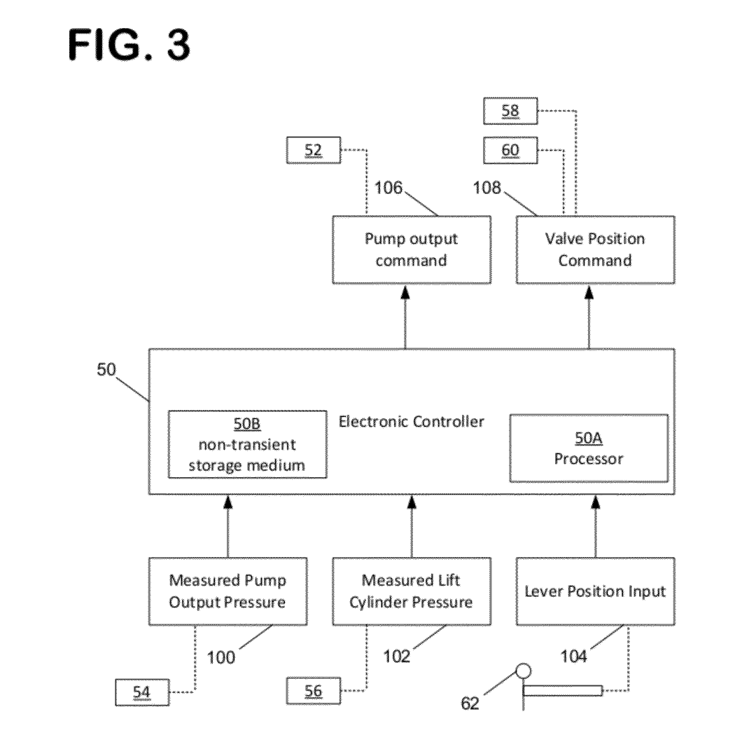

Referring to FIG. 3, the electronic controller 50 is schematically shown as including a processor 50A and a non-transient storage medium or memory 50B, such as RAM, flash drive or a hard drive. Memory 50B is for storing executable code, the operating parameters, the input from the operator interface while processor 50A is for executing the code. Electronic controller 50 is also shown as having a number of inputs and outputs that may be used for implementing the work circuit work mode and the work circuit standby mode. As stated above, one of the inputs is the measured pump output pressure 100 provided by the pressure sensor 52. Another input is the measured hydraulic actuator pressure 102 provided by pressure sensor 56. One skilled in the art will understand that many other inputs are possible. For example, measured engine speed may be provide as a direct input into the electronic controller 50 or may be received from another portion of the control system via a control area network (CAN). The measured pump displacement, for example via a displacement feedback sensor, may also be provided.

Another input into the electronic controller 50 is the lever position input 104 from a work lever 62. In one embodiment, the lever position input is a direct digital signal from an electronic lever, such as a lifting lever. The work lever 62 provides a user indication to the controller 50 that a load work operation by hydraulic actuator(s) 40 is desired.

Still referring to FIG. 3, a number of outputs from the electronic controller 50 are shown. One output is a pump output command 106 which is for adjusting the output pressure of the pump 102. In one embodiment, pump pressure output can be controlled by adjusting the angle of the swash plate in a variable displacement axial piston pump. Yet another output is the valve position command 108. In the particular embodiment shown, the valve command output 108 is a proportional signal to the solenoid valves 58, 60 of control valve 20 via control lines 66, 70. Additional valve output position commands can be sent to the devices 228 from controller 50.

The electronic controller 50 may also include a number of maps or algorithms to correlate the inputs and outputs of the controller 502. For example, the controller 502 may include an algorithm to control the pump output pressure and the position of the first valve assembly 20 based on the measured pressures at sensors 54 and 56. In one embodiment, the controller 50 includes an algorithm to control the system in a work mode and a work standby mode, as described further in the Method of Operation section below.

The electronic controller 50 may also store a number of predefined and/or configurable parameters and offsets for determining when each of the modes is to be initiated and/or terminated. As used herein, the term “configurable” refers to a parameter or offset value that can either be selected in the controller (i.e. via a dipswitch) or that can be adjusted within the controller.

### Method of Operation

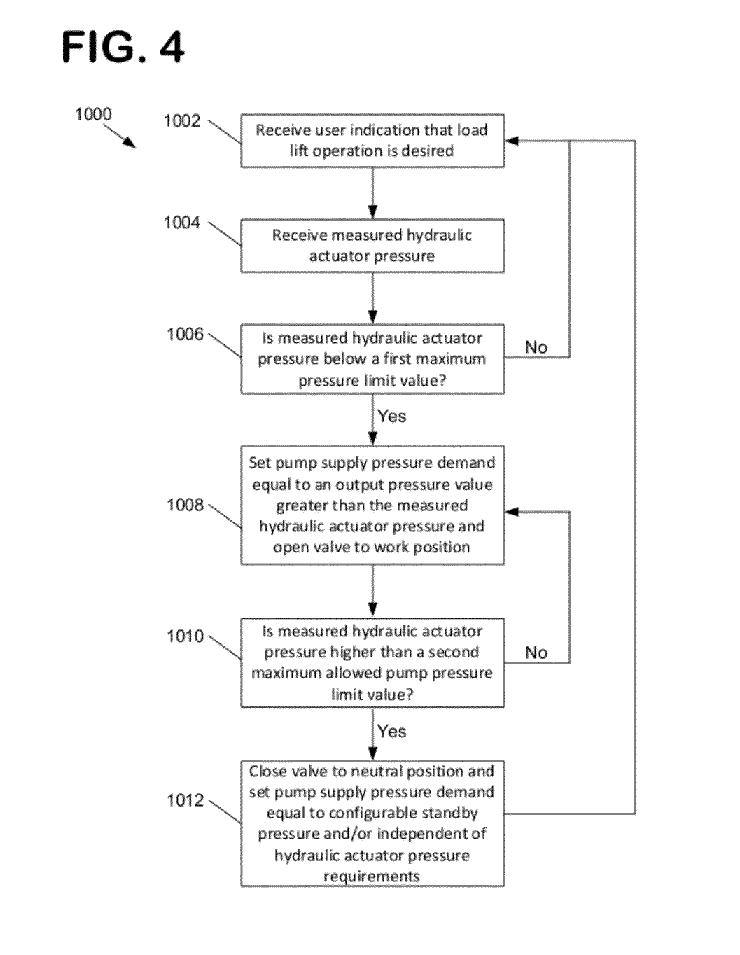

Referring to FIG. 4, a method 1000 of operating the pump 210 and control valve assembly 20 is shown. It is noted that although FIG. 4 diagrammatically shows the method steps in a particular order, the method is not necessarily intended to be limited to being performed in the shown order. Rather at least some of the shown steps may be performed in an overlapping manner, in a different order and/or simultaneously.

In a first step 1002 of the method 1000, the electronic controller 50 receives an indication from the user that the work mode of operation is desired. This indication may come from a variety of user inputs. For example, the user may move the lever associated with the hydraulic actuator(s) 40. Another example is the user selecting the mode directly or indirectly through the use of a user interface of the control system 500. For the purpose of simplicity, the system can be said to be in a work standby mode at step 1002, wherein the first control valve assembly is in a closed or neutral position and the pump pressure is controlled to a value that is independent of the measured hydraulic actuator hydraulic pressure. As such, in the work standby mode, the control system prevents the pump from being commanded to a full pressure output operating state even though a user moved the work lever to a work position.

In a second step 1004, the electronic controller 50 receives the measured hydraulic actuator pressure, for example from pressure sensor 56. Where a load is already placed on the work implement 202, this pressure corresponds to the induced pressure caused by the load 42.

In a third step 1006, a determination is made as to whether the measured hydraulic actuator pressure is below a first maximum pressure limit value. In one embodiment, the first maximum pressure limit value is equal to a maximum allowed pump pressure limit. In one embodiment, the first maximum pressure limit value is equal to the maximum allowed pump pressure limit summed with a first offset value. In one example, the first offset value is set to zero. Both the first maximum pressure limit value and the first offset value may be configurable within the controller 50 such that the values can adjusted and optimized for best performance of the system.

If the measured hydraulic actuator pressure is not below the first maximum pressure limit value, then the process is returned to the beginning where the system remains in the work standby mode. This condition would exist where the load 42 has induced a pressure that is too great for the pump 210 to overcome. As such, rather than commanding the pump to maximum pressure output, which would be a waste of energy, the system does not respond to the indication that a load lift operation is desired. In the work standby mode, the pump instead operates independently of the pressure required for the hydraulic actuators.

If the measured hydraulic actuator is below the first maximum pressure limit value, the process proceeds to step 1008 wherein the work mode is initiated. In the work mode, the pump is commanded to generate an output pressure value that is greater than the measured hydraulic actuator hydraulic pressure. Once the pump pressure has reached this value, the control valve is opened to the work position such that the hydraulic actuator(s) and the pump 210 are placed in fluid communication with each other. In one embodiment, the pump output pressure value is defined as the hydraulic actuator pressure, as measured at sensor 56, summed with a third offset value. In one example, the third offset value is about 10 bar. The third offset value may be configurable within the controller 50 such that the value can adjusted and optimized for best performance of the system.

In step 1010, a second determination is made as to whether the measured hydraulic actuator pressure is above a second maximum pressure limit value. In one embodiment, the second maximum pressure limit value is equal to a maximum allowed pump pressure limit. In one embodiment, the second maximum pressure limit value is equal to the maximum allowed pump pressure limit summed with a second offset value. In one example, the second offset value is about 5 bar. The second offset value may be configurable within the controller 50 such that the value can adjusted and optimized for best performance of the system.

If the measured hydraulic actuator pressure is below the second maximum pressure limit value, then the controller allows the system to remain in the work mode and the process returns to step 1008. However, if the measured hydraulic actuator pressure is above the second maximum pressure limit value, then the system is returned to the work standby mode at step 1012. As stated above, the work standby mode includes the valve being closed such that the pump and hydraulic actuator(s) are isolated from each other and the pump pressure output is set to either a standby pressure or a pressure that is otherwise operated independently of the requirements of the hydraulic actuator(s).

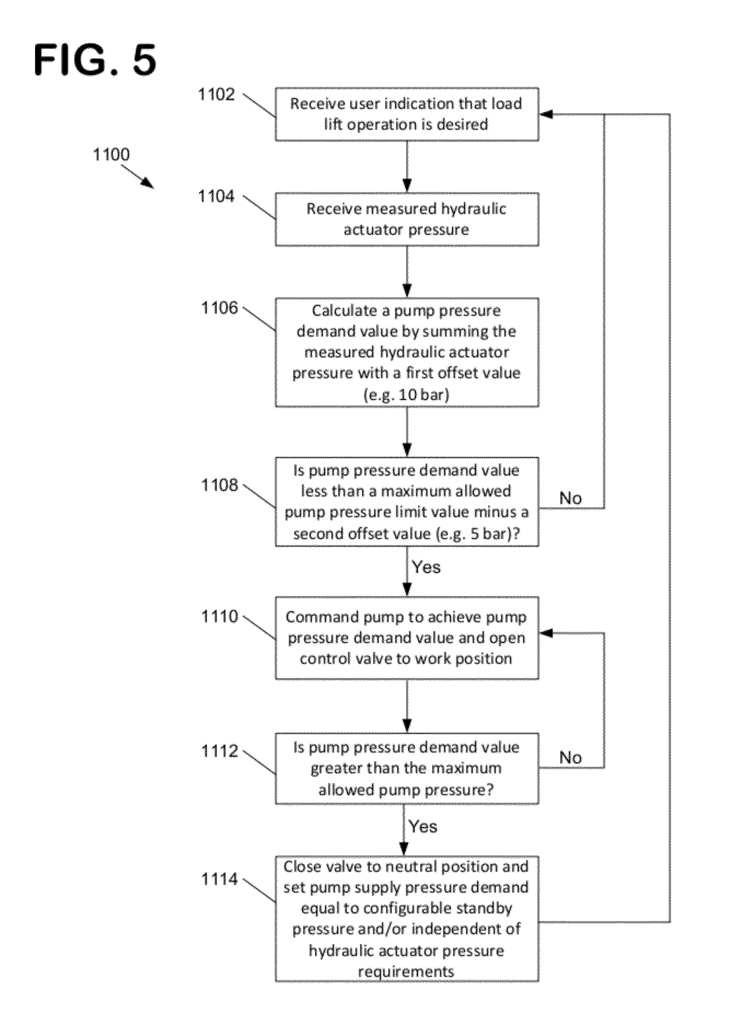

Referring to FIG. 5, a second method 1100 of operating the pump 210 and control valve assembly 20 is shown. It is noted that although FIG. 4 diagrammatically shows the method steps in a particular order, the method is not necessarily intended to be limited to being performed in the shown order. Rather at least some of the shown steps may be performed in an overlapping manner, in a different order and/or simultaneously. As many of the steps include features similar to that described for method 1000, the entirety of the description for method 1000 is hereby incorporated by reference into the description for method 1100, and vice versa.

Steps 1102 and 1104 are the same as steps 1002 and 1004 in method 1000, and will therefore not be discussed further.

In a step 1106, a pump pressure demand value is calculated by summing the measured lift cylinder pressure with an offset value. In one embodiment, the offset value is about 10 bar.

In a step 1108 a comparison is made between the pump pressure demand value and a maximum allowed pump pressure limit value minus a second offset value. In one embodiment, the second offset value is about 5 bar. If the pump pressure demand value is less than the pump pressure limit minus the second offset value, the circuit is placed in the work mode at step 1108. Otherwise, the circuit remains in the work standby mode and the process returns back to step 1102.

At step 1110, the pump is commanded to achieve the pump pressure demand value and the control valve is opened to the work position such that the pump and the hydraulic actuator are placed in fluid communication with each other.

At step 1112, a second comparison is made between the pump pressure demand value and the maximum allowed pump pressure. If the pump pressure demand value is less than the pump pressure limit, the circuit is continues to remain in the work mode and the process returns to step 1110. If the pump pressure demand value is greater than the pump pressure limit, the circuit is removed from the work mode and placed in the standby mode at step 1114.

At step 1114, the valve is closed to the neutral position such that the pump and the hydraulic actuator are isolated from each other. The pump pressure is also set to a supply pressure demand that is equal to a configurable standby pressure, equal to a pressure sufficient to meet another component in the system, or to a value that is otherwise independent of the hydraulic actuator pressure.

As should be appreciated, the above described processes and related disclosures allow for the system to operate the pump in a more economical manner by only commanding the pump to increase output pressure when it can be ascertained beforehand that the pump can actually produce the pressure that would be required for a work operation, such as a lifting operation.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A method of controlling a hydraulic circuit having a pump, a hydraulic actuator, and a control valve disposed between the pump and hydraulic actuator, the method comprising the steps of:
(a) receiving an indication that a work operation is desired by a work lever in the hydraulic circuit;
(b) receiving a measured hydraulic actuator hydraulic pressure;
(c) placing the hydraulic circuit in a work mode when the when the measured hydraulic actuator hydraulic pressure is below a first maximum pressure limit value, the work mode including:
i. moving the control valve to a work position such that the pump and hydraulic actuator are in fluid communication with each other;
ii. commanding the pump to generate an output pressure value that is greater than the measured hydraulic actuator hydraulic pressure when the measured hydraulic actuator hydraulic pressure is below the maximum pressure limit;
(d) placing the hydraulic circuit in a work standby mode when the measured hydraulic actuator hydraulic pressure is above a second maximum pressure limit value, the standby mode including:
i. moving the control valve to a closed position such that the pump is isolated from the hydraulic actuator;
ii. commanding the pump to generate an output pressure value that is independent of the measured hydraulic actuator hydraulic pressure.

2. The method of claim 1, wherein the first maximum pressure limit value includes an allowable maximum allowed pump pressure limit.

3. The method of claim 2, wherein the first maximum pressure limit includes a maximum allowed pump pressure limit summed with a first offset value.

4. The method of claim 1, wherein the second maximum pressure limit value includes an allowable maximum allowed pump pressure limit.

5. The method of claim 4, wherein the first maximum pressure limit includes a maximum allowed pump pressure limit summed with a second offset value.

6. The method of claim 3, wherein the first maximum pressure limit includes a maximum allowed pump pressure limit summed with a second offset value.

7. The method of claim 6, wherein the first offset value is about 0 bar and the second offset value is about 5 bar.

8. The method of claim 1, wherein the output pressure value of the pump in the work mode is set to equal the measured hydraulic actuator hydraulic pressure summed with a third offset value.

9. A hydraulic system for use in a mobile vehicle, the system comprising:
(a) an electronic controller;
(b) at least one hydraulic actuator;
(c) a hydraulic pump in communication with the electronic controller;
(d) a control valve in communication with the electronic controller, the control valve being disposed between the pump and the hydraulic actuator and being movable from a closed position to a work position in which the hydraulic actuator and hydraulic pump are placed in fluid communication with each other;
(e) a first pressure sensor in communication with the electronic controller, the first pressure sensor being for measuring a hydraulic pressure between the control valve and the hydraulic actuator; and
(f) a second pressure sensor in communication with the electronic controller, the second pressure sensor being for measuring a hydraulic pressure between the pump and the control valve;
(g) the electronic controller being configured to operate the system between a work mode and a work standby mode, the work mode being initiated when the hydraulic pressure at the first pressure sensor is below a first maximum pressure limit value, the work standby mode being initiated when the hydraulic pressure at the hydraulic pressure at the first pressure sensor is above a second maximum pressure limit value;
(h) the work mode including:
i. the control valve being in the work position;
ii. the pump being set to generate an output pressure value that is greater than the measured hydraulic actuator hydraulic pressure;
(i) the work standby mode including:
i. the control valve being in a closed position;
ii. the pump being set to generate an output pressure value that is independent of the measured hydraulic actuator hydraulic pressure.

10. The method of claim 9, wherein the first maximum pressure limit value includes an allowable maximum allowed pump pressure limit.

11. The method of claim 10, wherein the first maximum pressure limit includes a maximum allowed pump pressure limit summed with a first offset value.

12. The method of claim 9, wherein the second maximum pressure limit value includes an allowable maximum allowed pump pressure limit.

13. The method of claim 12, wherein the first maximum pressure limit includes a maximum allowed pump pressure limit summed with a second offset value.

14. The method of claim 11, wherein the first maximum pressure limit includes a maximum allowed pump pressure limit summed with a second offset value.

15. The method of claim 14, wherein the first offset value is about 0 bar and the second offset value is about 5 bar.

16. The method of claim 9, wherein the output pressure value of the pump in the work mode is set to equal the measured hydraulic actuator hydraulic pressure summed with a third offset value.

17. An electronic controller for use in a hydraulic circuit having a pump, a hydraulic actuator, and a control valve disposed between the pump and hydraulic actuator comprising:
(a) a non-transient storage medium;
(b) a processor;
(c) a control algorithm stored on the non-transient storage medium and executable by the processor;
(d) the control algorithm being configured to allow the electronic controller to operate the hydraulic circuit between a work mode and a work standby mode, the work mode being initiated when a measured hydraulic pressure associated with the hydraulic actuator is below a first maximum pressure limit value, the work standby mode being initiated when the measured hydraulic pressure is above a second maximum pressure limit value;
(e) the work mode including:
i. the control valve being in a work position;
ii. the pump being set to generate an output pressure value that is greater than the measured hydraulic actuator hydraulic pressure;
(f) the work standby mode including:
i. the control valve being in a closed position;
ii. the pump being set to generate an output pressure value that is independent of the measured hydraulic actuator hydraulic pressure.

18. The method of claim 17, wherein the first maximum pressure limit value includes an allowable maximum allowed pump pressure limit.

19. The method of claim 18, wherein the first maximum pressure limit includes a maximum allowed pump pressure limit summed with a first offset value.

20. The method of claim 17, wherein the second maximum pressure limit value includes an allowable maximum allowed pump pressure limit.

21. The method of claim 20, wherein the first maximum pressure limit includes a maximum allowed pump pressure limit summed with a second offset value.

22. The method of claim 19, wherein the first maximum pressure limit includes a maximum allowed pump pressure limit summed with a second offset value.

23. The method of claim 22, wherein the first offset value and the second offset values are configurable within the controller.

24. The method of claim 22, wherein the first offset value is about 0 bar and the second offset value is about 5 bar.

25. The method of claim 17, wherein the output pressure value of the pump in the work mode is set to equal the measured hydraulic actuator hydraulic pressure summed with a third offset value.

26. The method of claim 25, wherein the third offset value is configurable within the controller.

27. The method of claim 26, wherein the third offset value is about 10 bar.
